(19) United States
(12) Patent Application Publication
(10) Pub. No.: US 2002/0138698 A1
(43) Pub. Date: Sep. 26, 2002

(54) System and method for caching directory information in a shared memory multiprocessor system

(75) Inventor: Ronald Nick Kalla, Round Rock, TX (US)

Correspondence Address: Andrew J. Dillon, BRACEWELL & PATTERSON, L.L.P., Suite 350 Lakewood on the Park, 7600B North Capital of Texas Highway, Austin, TX, 78731, US

(73) Assignee: International Business Machines Corporation

(21) Appl. No.: 09/813,490

(22) Filed: Mar. 21, 2001

(51) Int. Cl. G06F 13/00

(52) U.S. Cl. 711/130; 711/147

(57) ABSTRACT

A system and method for maintaining cache coherency in a shared memory multiprocessor system. A plurality of multiprocessor elements are coupled to a network. The multiprocessor elements include a local cache memory, a local cache directory, a plurality of remote memory controllers, and a network interface chip which couples multiple processing elements to the network. A partial directory cache is stored in the local memory of the network interface unit. The partial directory cache is accessed to locate which one of the multiprocessing elements has a requested data element in the event of a local cache miss. Since the partial directory is stored in the local memory system of the network interface unit, this reduces the need to access the full directory stored in the slower, off-chip shared memory system. In the event of a miss in the partial directory cache, the full directory list stored in the off-chip shared memory system is accessed to find the location of the requested data element.

### 1. TECHNICAL FIELD

The present invention relates in general to the field of data processing systems, and in particular to the field of data processing systems utilizing more than one data processing element. Still more particularly, the present invention relates to a method and apparatus for improving cache coherency and cache miss latency times in data processing systems utilizing more than one data processing element.

### 2. DESCRIPTION OF THE RELATED ART

Modem processors, also called microprocessors, use many techniques including pipelining, superpipelining, superscaling, speculative instruction execution, and out-of-order instruction execution to enable multiple instructions to be issued and executed each clock cycle. As utilized herein the term “processor” includes complex instruction set computers (CISC), reduced instruction set computers (RISC) and hybrids. The ability of processors to execute instructions has typically outpaced the ability of memory subsystems to supply instructions and data to the processors. Consequently, most processors use a cache memory system to speed memory access.

Cache memory typically includes one or more levels of dedicated high-speed memory storing recently accessed data or instructions, designed to speed up subsequent access to the same data or instructions. Cache technology is based on the premise that programs frequently re-access the same instructions and data. When data or instructions are read from main system memory, a copy is also saved in the cache memory, along with an index to the associated main memory. The cache then monitors subsequent requests for data or instructions to see if the information needed has already been stored in the cache. If the data or instructions have indeed been stored in the cache, the data or instructions are delivered immediately to the processor while the attempt to fetch the information from main memory is aborted (or not started). If, on the other hand, the data or instructions have not been previously stored in cache then it is fetched directly from main memory and also saved in cache for future access.

Modern processors typically support multiple cache levels, most often two or three levels of cache. A level one cache (L1 cache) is usually an internal cache built onto the same monolithic integrated circuit as the processor itself. On-chip cache is the fastest (i.e., lowest latency) because it is accessed by the internal components of the processor. On the other hand, off-chip cache is an external cache of static random access memory (SRAM) chips plugged into a motherboard. Off-chip cache has much higher latency, although is typically much shorter latency than accesses to main memory.

Modern processors pipeline memory operations to allow a second load operation to enter a load/store stage in an execution pipeline before a first load/store operation has passed completely through the execution pipeline. Typically, a cache memory that loads data to a register or stores data from the register is outside of the execution pipeline. When an instruction or operation is passing through the load/store pipeline stage, the cache memory is accessed. If valid data is in the cache at the correct address a “hit” is generated and the data is loaded into the registers from the cache. When requested data is not in the cache, a “miss” is generated and the data must be fetched from a higher cache level or main memory. The latency (i.e., the time required to return data after a load address is applied to the load/store pipeline) of higher cache levels and main memory is significantly greater than the latency of lower cache levels.

The term “coherency” and more particularly “cache coherency,” as applied to microprocessor (MP) computer systems refers to the process of tracking data that is moved between local memory and the cache memories of the multiple processors. For example, in a typical MP environment, each processor has its own cache memory while all of the processors (or a subset of all the processors) share a common memory. If a processor requests particular data from memory, an investigation must be made to determine if another processor has already accessed that data and is holding the most updated copy in that processor's cache memory. If this has occurred, the updated data is sent from that processor's cache memory to the requesting processor and the read from memory is aborted. Thus, coherency or cache coherency refers to the process of tracking which data is in memory and which data has a more recent version in a processor's cache. While achieving coherency in an MP computing system is challenging, the challenge is increased when the multiple processors are clustered in subsets on local buses that are connected by a system bus.

The prior art includes many techniques for achieving coherent cache operation. One well known technique is bus snooping. All cache controllers monitor, or “snoop,” on a common bus to determine whether or not they have a copy of some shared data which another processor has requested. This is especially useful in systems with single buses to main memories. All processing elements with caches see all bus transaction and take appropriate actions, such as, requesting needed data to be transferred from another processing element. The main advantage of a snooping protocol is that directory information on the location of the data is maintained only for lines that are cached. Since caches are relatively small compared to the size of main memory, the directory information can usually be kept in an on-chip SRAM, which is much faster than the higher capacity system dynamic random access memory (DRAM).

Another technique utilizes a coherency directory. A coherency directory includes a memory system coupled to a local memory that tracks which processor or processor clusters have cached versions of a line for a particular memory entry. When a processor requests specific data in memory, the memory controller for that memory determines whether the requested data is available for transfer. The coherency directory will indicate if the data has been accessed by one or more processors and where those processors are located. Amongst other features, coherency directories permit efficient cache coherency within a computer system having a distributed or multi-level bus interconnect. The advantage of this protocol is that bus or network transactions are only sent to processing elements that have cached copies of data. This reduces bus or network traffic and therefore increases the available bandwidth for data processing.

There are, however, certain inherent problems in both of these popular protocols. In the snooping protocol, the main disadvantage is that all bus transactions must be broadcast to all processing elements. This increases bus or network traffic, and thus, lowers available bandwidth. The directory-based protocol keeps the directory information, which must be maintained for every line in cache memory in slower, off-chip DRAM. Therefore, for every cache miss, the latency is high, since the slower DRAM must be accessed to refer to the directory information.

### SUMMARY OF THE INVENTION

It is therefore one object of the present invention to provide an improved data processing system.

It is another object of the present invention to provide an improved data processing system utilizing more than one data processing element.

It is yet another object of the present invention to provide an improved cache coherency method and system for data processing systems utilizing more than one data processing element while decreasing the latency for cache misses.

A system and method are disclosed for maintaining cache coherency in a shared memory multiprocessor system. In a preferred embodiment of the present invention, multiple processor elements are coupled to a network. Those skilled in the art will readily appreciate that the network can include a bus, a switch, or any other interconnect. The processor elements include a local cache memory, a local cache directory, a memory controller, and a network interface chip which couples a plurality of processing elements to the network. A partial directory cache is stored in the local memory of the network interface unit. In the cache coherency method of the present invention, the partial directory cache is accessed to locate which one of the processing elements has a requested data element in the event of a local cache miss. Since the partial directory is stored in the local memory system of the network interface unit, this reduces the need to access the full directory stored in the slower, off-chip shared memory system. In the event of a miss in the partial directory cache, the full directory list stored in the off-chip shared memory system is accessed to find the location of the requested data element. The present invention reduces the time penalty for a cache miss, thus improving the execution speed of the overall multiprocessor system.

### BRIEF DESCRIPTION OF THE DRAWINGS

The novel features believed characteristic of the invention are set forth in the appended claims. The invention itself; however, as well as a preferred mode of use, further objects and advantages thereof, will best be understood by reference to the following detailed description of an illustrative embodiment when read in conjunction with the accompanying drawings, wherein:

FIG. 1 is a pictorial representation of a multiprocessor system, including a network, a shared main memory system, and multiple processing elements, which may be utilized to implement the present invention;

FIG. 2 depicts a detailed block diagram of a single processing element shown FIG. 1 in accordance with the method and system of the present invention;

FIG. 3 illustrates a pictorial representation of the network interface unit in a preferred embodiment of the present invention;

FIG. 4 depicts the fields of the partial directory cache stored in the local memory system of the network interface unit in accordance with a preferred embodiment of the present invention;

FIG. 5 illustrates the fields of a full memory directory stored in the shared main memory system in accordance with a preferred embodiment of the present invention; and

FIG. 6 depicts a flowchart outlining the cache coherency method of the present invention in accordance with the method and system of the present invention.

### DETAILED DESCRIPTION OF THE PREFERRED EMBODIMENT

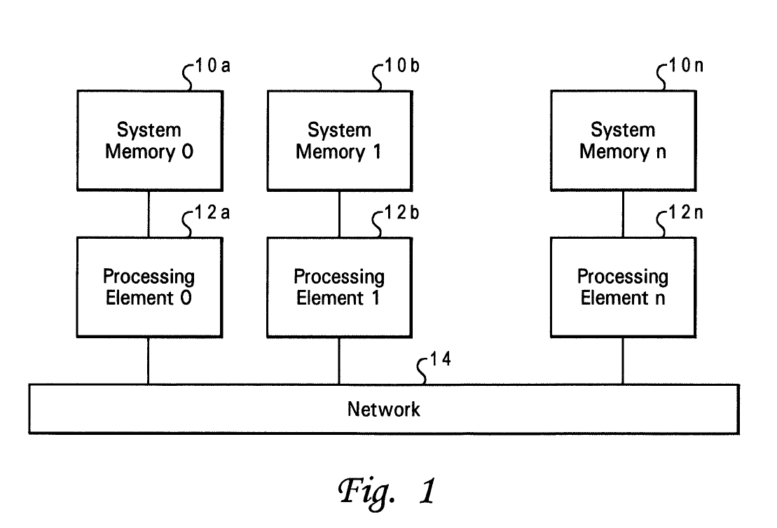

With reference now to the figures, and in particular with reference to FIG. 1, there is depicted a multiprocessor data processing system including multiple processing elements, generally referred to as 12a/n and a shared main system memory referenced as 10a/n. Both of these aforementioned components are coupled by a network 14. It should be readily apparent to those skilled in the art that the network can include a bus, a switch, or any other type of interconnect. Those skilled in the art will also appreciate that the depiction in FIG. 1 can be an illustration of any shared memory multiprocessor system lo architecture, with some examples being symmetric multiprocessors (SMP) and nonuniform memory access multiprocessors (NUMA) architectures.

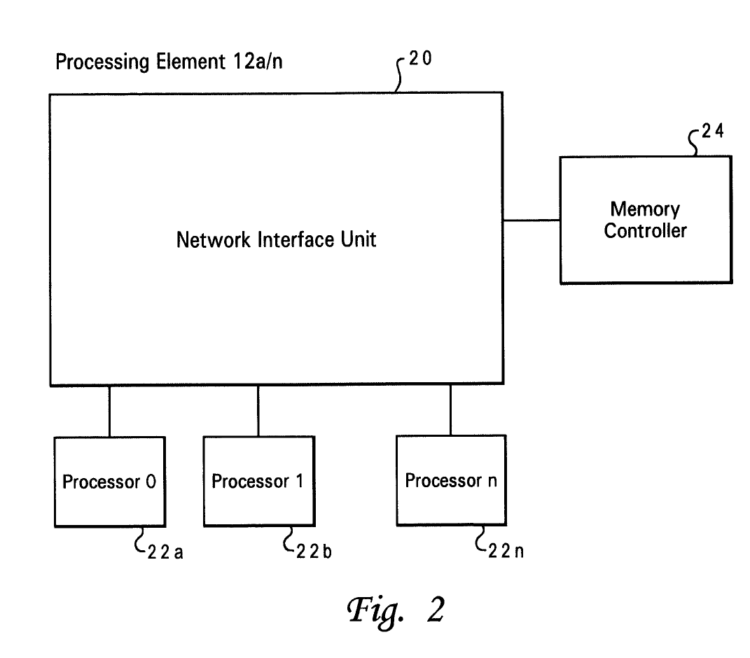

Referring now to FIG. 2, a more detailed view of processing element 10a/n is illustrated. Processing element 10a/n includes a network interface unit 20, multiple processors, generally referred to as 22a/n, and a memory controller (MC) 24. MC 24 controls a portion of shared main system memory 10a/n that can be accessed by processing elements 12a/n. Network interface unit 20 couples processors 22a/n to network 14. In a preferred embodiment of the present invention, shared main system memory 10a/n contains data elements and a full memory directory 50, which stores all the information contained in all local cache memory directories 32 of processing elements 12a/n. When one processing element requests a data element that is not stored in local cache 30, the system can refer to full memory directory 50 to determine if a modified copy of the requested data exists in another processing element. This enables the system to keep track of the locations of the data in each processing element 12a/n and allows the system to relay data requested by one processing element from another processing element that contains the requested data in its local cache 30.

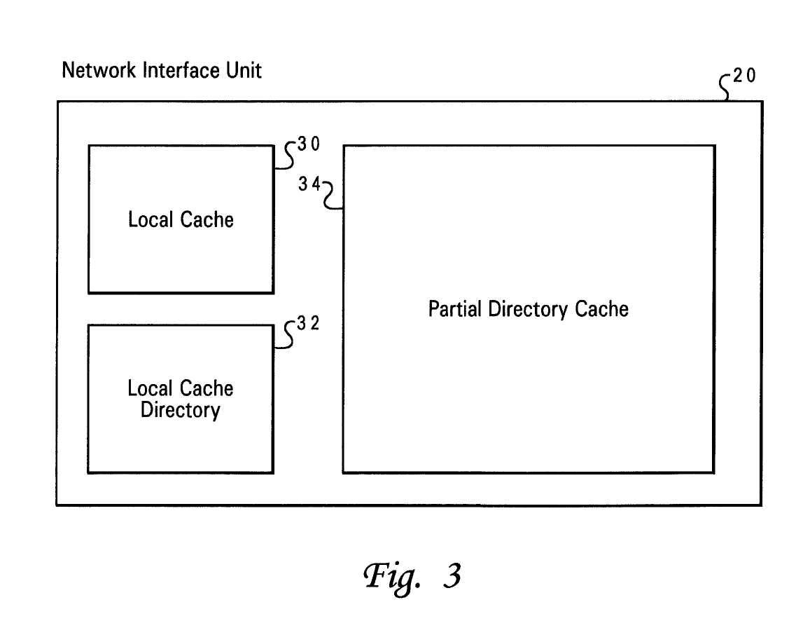

With reference now to FIG. 3, network interface unit 20 is depicted in accordance with the present invention. Network interface unit 20 includes a local cache 30, a local cache directory 32, and a partial directory cache 34. In a preferred embodiment of the present invention, this block is the coherency point of processors 22a/n. Processors 22a/n refer to this point to find the location of the most recently updated copy of the requested data. Local cache 30 stores recently referenced data and local cache directory 32 catalogues the contents of local cache 30. If there is a miss in local cache 30, partial directory cache 34 is accessed. This element contains a subset of the information contained in full memory directory 50. Full memory directory 50, is stored in the slower, main system memory 10a/n, while partial directory cache 34 is stored in the faster, local memory of network interface unit 20. The thrust of the present invention is to substantially reduce the latency time of providing data to the correct processing element 12a/n by accessing full memory directory 50 only when there is a miss in partial directory cache 34. Because full memory directory 50 is stored in slower, shared system memory 10a/n, it is advantageous to limit access to full memory directory 50 and to attempt to pull needed directory information from partial directory cache 34 when it is available. Also, read modify write operations to shared main system memory 10a/n to update full memory directory 50 are reduced. This is because the cached directory information in network interface unit 14 can be used to filter fill directory updates to shared main system memory 10a/n.

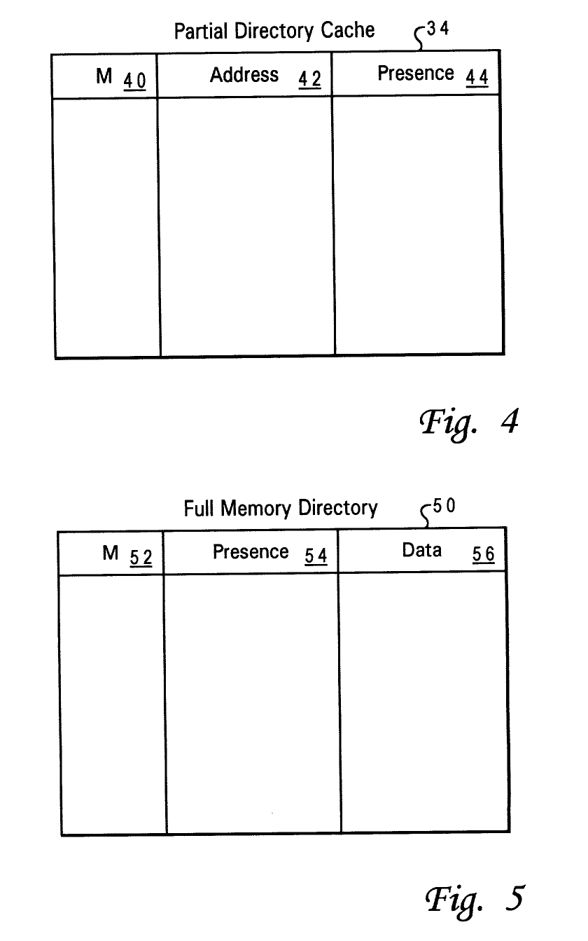

With reference now to FIG. 4, the fields of partial directory cache 34 are illustrated. A state field 40 indicates the status of the referenced data element. If the data element has been modified, state field 40 is set. It should be readily apparent to those skilled in the art that when a field is set, it can be at logic high or low depending on if the circuit is active high or active low. Also, if state field 40 is set, all other copies of the referenced data element are considered invalid. Address field 42 indicates within which line in system memory 10a/n the requested data is stored. Presence field 44 designates which processing elements have cached copies of the requested data element. When there is a miss in local cache 30 in processing element 12a/n, partial directory cache 34 is accessed, and the contents of state field 40, address field 42, and presence field 44 are examined. The directory information is utilized to determine if there exists a modified or shared copy of the requested data in another processing element. If a modified or shared copy exists, a message is sent through the network to have the processing element with the modified copy provide the data to the element with a local cache miss. By using the information in presence field 44, the requested data can be located and relayed to the proper processing element 12a/n. However, if there is a miss in partial directory cache 34, a search of full memory directory 50 is performed. It should be readily apparent to those skilled in the art that partial directory cache 34 may be organized the same as tradition caches using n-way associativity and various documented replacement algorithms. However, if the information in full memory directory 50 is not kept up to date with partial directory cache 34, it will be necessary to cast out, or update directory information whenever replacement occurs.

With reference to FIG. 5, the fields of full memory directory 50 are illustrated. Full memory directory 50 is stored in system memory 10a/n, and contains several important fields similar to the fields in partial directory cache 34. State field 52 indicates the status of the referenced data element. If the data element has been modified, state field 52 is set. Those skilled in the art should know when a field is set, it can be at logic high or low depending on whether the circuit is active high or active low. Also, if state field 52 is set, all other copies of the referenced data element are considered invalid. Presence field 54 signifies which processing elements have cached copies of the requested data element. The actual data element is stored in a data field 56. When there is a miss in partial directory cache 34, a search of full memory directory 50 is performed. This time, presence field 54 is accessed and a location of the requested data is determined. If, however, none of local caches 30 in processing elements 12a/n contain the data, a copy of data field 56 is made and sent to the requesting processing element. Another advantage of the present invention is that the directory information is kept in the same line in memory as the data. Therefore, during system startup, the data can be accessed when full memory directory 50 is accessed to determine if there are cached copies of the requested data.

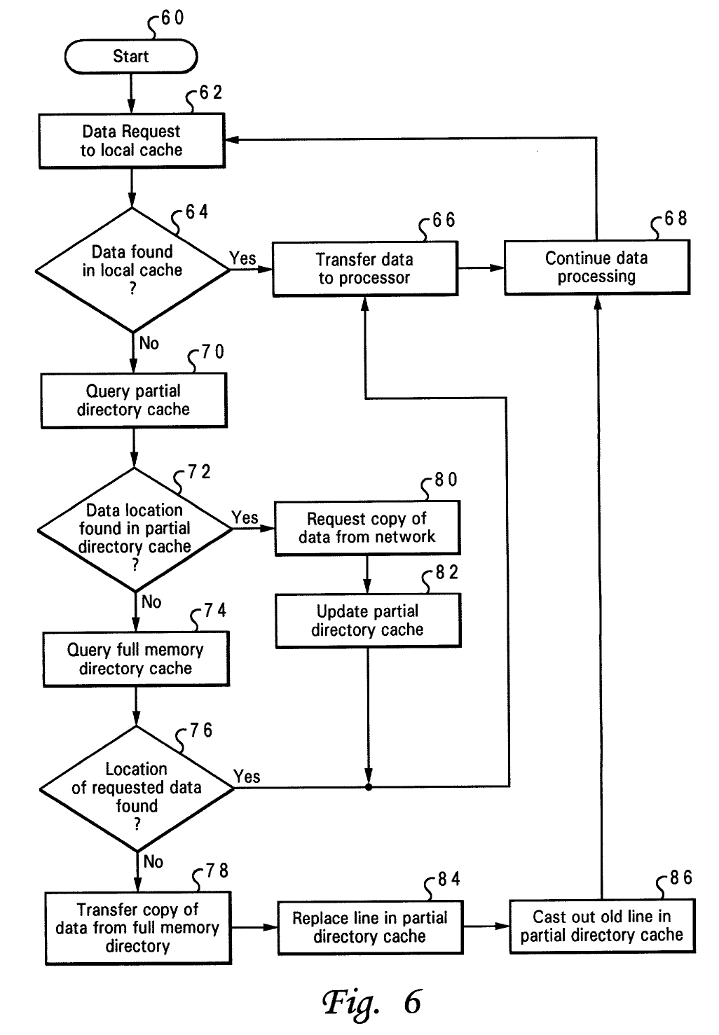

Referring now to FIG. 6, there is depicted a logic flowchart illustrating the implementation of the cache coherency scheme of the present invention. As is illustrated, the process begins at block 60 and then passes to block 62, which depicts the beginning of a data request procedure. Block 64 illustrates a determination of whether or not the requested data is found in local cache directory 32, and if so, block 66 illustrates the transfer of the requested data to the proper processor 22a/n. The operation then proceeds to continue data processing, as depicted in block 68. However, if the requested cache line tag is not found in local cache directory 32, the process passes to block 70, where a query to partial directory cache 34 is depicted. The operation then proceeds to block 72, for a determination of whether of not the requested data location is found in partial directory cache 34. If so, a copy of data is requested from network 14 and partial directory cache 34 is updated, as illustrated in blocks 80 and 82. The process then continues to blocks 66 and 68, where the requested data is transferred to the proper processing element 12a/n and data processing continues. If the requested cache line tag is not found in partial directory cache 34, the operation proceeds to block 74, where full memory directory cache 50 is queried. The procedure then continues to block 76, and there is depicted a determination of whether or not the location of the requested data is found. If so, the process continues as before, to blocks 66 and 68, where the requested data is transferred to the proper processing elements 12a/n and the operation continues data processing. Finally, if the requested data is not stored in any local cache memory 30, a copy of the data is transferred from data field 56 in full memory directory 50, as depicted in block 78. Then, the copy of data replaces the older data in partial directory cache 34 as illustrated in block 84. As depicted in block 86, the older data in partial directory cache 34 is cast out. The process then continues to block 68, where data processing continues.

While the invention has been particularly shown and described with reference to a preferred embodiment, it will be understood by those skilled in the art that various changes in form and detail may be made therein without departing from the spirit and scope of the invention.

What is claimed is:

1. A multiprocessor system, comprising:
an interconnect;
a shared system memory coupled to said interconnect;
a full memory directory stored in said shared system memory; and
a plurality of processing elements coupled to said interconnect, wherein a first processing element among said plurality of multiprocessing elements includes:
a local cache memory;
a local cache directory for storing tags associated with cache lines within said local cache memory; and
a partial directory cache that caches a portion of said full memory directory, wherein said partial directory cache is accessed to locate which one of said plurality of processing elements has a requested data element when there is a cache miss in said local cache memory before accessing said full memory directory.

2. The multiprocessor system of claim 1, wherein said full memory directory cache further comprises:
a presence field indicating which one of said plurality of multiprocessing elements contains the said requested data;
a state field indicating that said cache line is modified in one of said plurality of multiprocessing elements; and
an data field containing said requested data.

3. A processing element, comprising:
a local cache memory;
a local cache directory for storing tags associated with cache lines within said local cache memory; and
a partial directory cache for caching a portion of a full memory directory, wherein said partial directory cache is accessed to locate which one of said plurality of processing elements has a requested data element when there is a cache miss in said local cache memory before accessing said full memory directory.

4. A processing element, according to claim 3, which includes a memory controller that controls access to a shared system memory.

5. A partial directory cache stored in said local memory system, wherein said partial directory cache is accessed to locate which one of a plurality of processing elements has a requested data element when there is a cache miss in a local cache memory of one of said plurality of processing elements before accessing a full directory stored in a shared system memory.

6. The partial directory cache, according to claim 5, further comprises:
a presence field indicating which one of said plurality of processing elements contains the said requested data;
a state field indicating that said cache line is modified in one of said plurality of processing elements; and
an address field referencing where in said full memory directory a requested data element is stored

7. A method for caching directory information in a multiprocessor system provided with an interconnect, a shared memory system memory, and a plurality of processing elements, said method comprising:
accessing a partial directory cache, in response to a request for a data element;
reading the tag of said data element to determine location of said data element, in response to a hit in said partial directory cache;
accessing a full memory directory to determine location of said data element, in response to a miss in said partial directory cache;
retrieving requested said data element from one of said plurality of processing elements; and
reading directory information and data element directly from said full memory directory, in response to not locating said data element any of said plurality of processing elements.
